(19) United States
(12) Patent Application Publication
(10) Pub. No.: US 2023/0236142 A1
(43) Pub. Date: Jul. 27, 2023

(54) X-RAY ANALYZER

(71) Applicant: Shimadzu Corporation, Kyoto-shi (JP)

(72) Inventors: Yuji MORIHISA, Kyoto-shi (JP); Kriengkamol TANTRAKARN, Kyoto-shi (JP); Kanji KOBAYASHI, Kyoto-shi (JP); Keijiro SUZUKI, Kyoto-shi (JP)

(73) Assignee: Shimadzu Corporation, Kyoto-shi (JP)

(21) Appl. No.: 18/013,198

(22) PCT Filed: Jul. 1, 2020
(86) PCT No.: PCT/JP2020/025763

§ 371 Date: Dec. 27, 2022

(51) Int. Cl. G01N 23/223; G01N 23/2204

(52) U.S. Cl. CPC G01N 23/223; G01N 23/2204

(57) ABSTRACT

An X-ray analyzer includes a sample container for accommodating a sample, a placement portion capable of placing the sample container thereon, an X-ray irradiation source for irradiateing the sample with X-rays from below the placement portion, a detector for detecting fluorescent X-rays generated from the sample below the placement portion, and a holder placed on the placement portion, and configured to accommodate the sample container. The placement portion has an opening. The sample container includes a container body for surrounding the sample, the container body beings having a shape opened downward, and a container film configured to close an opening of the container body and support the sample. The holder includes an enclosure cylinder having an outer shape larger than the opening, the to surround the sample container, and having a shape opened downward, and a holder film closing an opening of the enclosure cylinder.

### TECHNICAL FIELD

The present invention relates to an X-ray analyzer.

### BACKGROUND ART

Conventionally, an X-ray analyzer for analyzing fluorescent X-rays generated from a sample irradiated with X-rays has been known. For example, Japanese Unexamined Patent Application Publication No. 2018-63196 discloses an X-ray analyzer provided with a housing having a placement portion configured to place a sample thereon, an X-ray tube for irradiating the sample with X-rays through an opening provided in the placement portion, and a detector for detecting fluorescent X-rays generated form the sample. The X-ray tube and the detector are arranged below the placement portion. The sample is placed on the placement portion via a film.

### PRIOR ART DOCUMENT

### Patent Document

Patent Document 1: Japanese Unexamined Patent Application Publication No. 2018-63196

### SUMMARY OF THE INVENTION

### Problems to Be Solved by the Invention

In an X-ray analyzer as described in Japanese Unexamined Patent Application Publication No. 2018-63196, there is a case in which a part of a sample drops through the opening due to the breakage of the film or the like and adheres to the detector. In such a case, there is a concern that the analysis accuracy deteriorates.

An object of the present invention is to provide an X-ray analyzer capable of suppressing dropping of a sample from a placement portion.

### Means for Solving the Problems

According to one aspect of the present invention, an X-ray analyzer is provided with:
a sample container configured to accommodate a sample;
a placement portion capable of placing the sample container thereon;
an X-ray irradiation source configured to irradiate the sample in the sample container with X-rays from below the placement portion;
a detector configured to detect fluorescent X-rays generated from the sample below the placement portion; and
a holder placed on the placement portion, the holder being configured to accommodate the sample container,
wherein the placement portion is provided with an opening for passing X-rays emitted from the X-ray irradiation source,
wherein the sample container includes:
   a container body configured to surround the sample, the container body being formed in a shape having an opening opened downward; and
   a container film configured to close the opening of the container body and support the sample, and
wherein the holder includes:
   an enclosure cylinder having an outer shape larger than the opening of the placement portion, the enclosure cylinder being configured to surround the sample container, the enclosure cylinder being formed in a shape having an opening opened downward; and
   a holder film closing the opening of the enclosure cylinder.

### Effects of the Invention

In this X-ray analyzer, the holder film is further arranged below the container film supporting the sample. Therefore, even in a case where the container film is damaged, dropping of the sample from the placement portion is suppressed.

### BRIEF DESCRIPTION OF THE DRAWINGS

FIG. 1 is a diagram schematically showing a configuration of an X-ray analyzer according to one embodiment of the present invention.

FIG. 2 is enlarged view in the vicinity of a sample container and a holder.

FIG. 3 is a cross-sectional view schematically showing a modification of the holder.

FIG. 4 is a cross-sectional view schematically showing a modification of a sample container.

### EMBODIMENTS FOR CARRYING OUT THE INVENTION

Some embodiments of the present invention will be described with reference to the attached drawings. Note that in the drawings referred to below, the same or corresponding member is denoted by the same reference symbol.

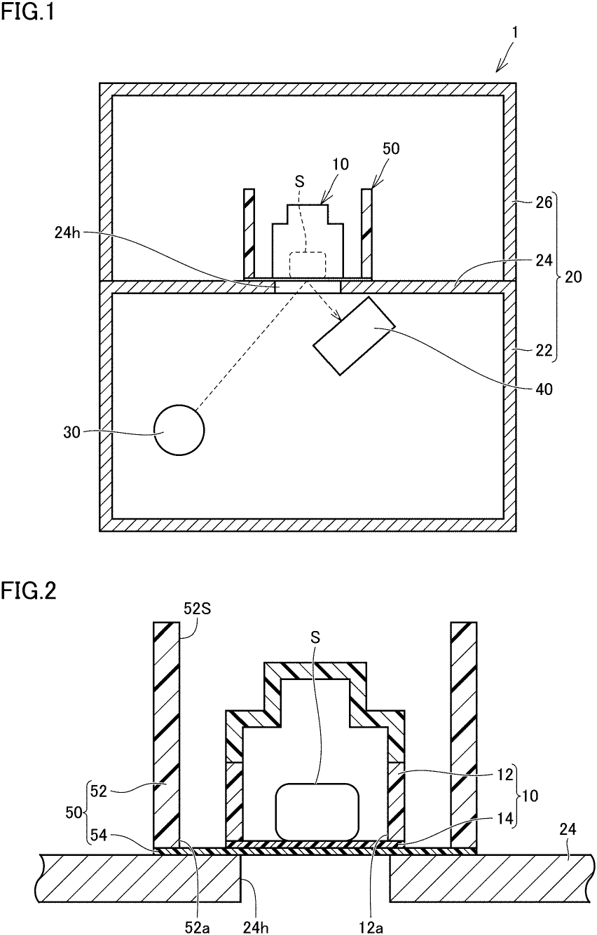

FIG. 1 is a diagram schematically showing a configuration of an X-ray analyzer according to one embodiment of the present invention. As shown in FIG. 1, the X-ray analyzer 1 is provided with a sample container 10, a casing 20, an X-ray irradiation source 30, a detector 40, and a holder 50.

The sample container 10 is a container for accommodating a sample S. As shown in FIG. 2, the sample container 10 includes a container body 12 and a container film 14.

The container body 12 surrounds the sample S and has a shaped opened downward. The container body 12 is made of, for example, polypropylene (PP).

The container film 14 closes the opening 12a (see FIG. 2) of the container body 12 and supports the sample S. In this embodiment, the container film 14 is made of polypropylene. The container film 14 is welded to the lower end of the container body 12. The container film 14 may be made of polyethylene terephthalate (PET) or the like.

The casing 20 accommodates the sample container 10 and the like. The casing 20 is made of a metallic material. As shown in FIG. 1, the casing 20 includes a housing 22, a placement portion 24, and a cover 26.

The housing 22 is constituted by the lower portion of the casing 20. The housing 22 accommodates the X-ray irradiation source 30 and the detector 40. The housing 22 has a shape opened upward.

The placement portion 24 is connected to the upper end of the housing 22. The placement portion 24 is a portion on which the sample container 10 is placed. The placement portion 24 is provided with an opening 24h for passing the X-rays emitted from the X-ray irradiation source 30. The opening 24h is set to be smaller than the outer shape of the container body 12. In other words, the outer shape of the container body 12 is larger than the opening 24h.

The cover 26 surrounds the sample container 10. The lower end of the cover 26 is connected to the outer edge of the placement portion 24.

The X-ray irradiation source 30 is accommodated in the housing 22. The X-ray irradiation source 30 irradiates the sample S placed in the sample container 10 with the X-rays from below the placement portion 24. As an example of the X-ray irradiation source 30, an X-ray tube is exemplified.

The detector 40 is accommodated in the housing 22. The detector 40 detects the fluorescent X-rays generated from the sample S that received the X-rays emitted from the X-ray irradiation source 30 below the placement portion 24. From the viewpoint of enhancing the analysis accuracy of the sample S, the detector 40 is preferably arranged in the vicinity of the opening 24h.

The holder 50 is placed on the placement portion 24 and accommodates the sample container 10. The holder 50 is configured to be removable from the placement portion 24. As shown in FIG. 2, the holder 50 includes an enclosure cylinder 52 and a holder film 54.

The enclosure cylinder 52 has a profile larger than the opening 24h. The enclosure cylinder 52 surrounds the sample container 10 and has a shape opened downward. In this embodiment, the enclosure cylinder 52 is formed in a cylindrical shape. The enclosure cylinder 52 is made of, for example, polypropylene. The height of the enclosure cylinder 52 is greater than the height of the sample container 10. The position of the enclosure cylinder 52 with respect to the opening 24h is determined by a positioning mechanism (not shown). The inner peripheral surface 52S of the enclosure cylinder 52 may gradually decrease in diameter as it approaches the placement portion 24. With this configuration, the sample container 10 is guided to a predetermined position when placing the sample container 10 in the enclosure cylinder 52 from above the enclosure cylinder 52.

The holder film 54 closes the opening 52a (see FIG. 2) of the enclosure cylinder 52. That is, two films (the container film 14 and the holder film 54) are laminated above the opening 24h. The holder film 54 is made of, for example, polypropylene. The holder film 54 is welded to the lower end of the enclosure cylinder 52. The thickness of the holder film 54 is approximately the same as the thickness of the container film 14. For example, the thickness of the holder film 54 is preferably set to 0.5 times or more and 2 times or less the thickness of the container film 14. Note that the holder film 54 may be made of polyethylene terephthalate (PET) or the like.

As described above, in the X-ray analyzer 1 according to this embodiment, the holder film 54 is further arranged below the container film 14 supporting the sample S. Therefore, even in a case where the container film 14 is, for example, damaged, dropping of the sample S from the placement portion 24 is suppressed. Therefore, contamination or the like of the detector 40 is suppressed.

It should be understood that the embodiments disclosed here are examples in all respects and are not restrictive. The scope of the present invention is indicated by claims rather than by the above-described descriptions of the embodiments and includes all modifications within the meanings and scopes equivalent to claims.

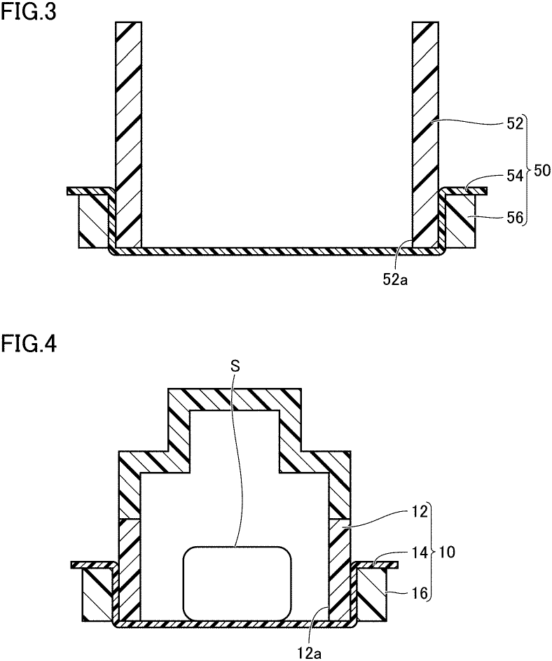

For example, as shown in FIG. 3, the holder 50 may further include a clamping ring 56. In this embodiment, the outer shape of the holder film 54 is set to be larger than the outer shape of the enclosure cylinder 52. The clamping ring 56 sandwiches the edge of the holder film 54 between the inner peripheral surface of the clamping ring 56 and the outer peripheral surface of the enclosure cylinder 52.

Further, as shown in FIG. 4, the sample container 10 may further include a clamping ring 16. In this embodiment, the outer shape of the container film 14 is set to be larger than the outer shape of the container body 12. The clamping ring 16 sandwiches the edge of the container film 14 between the inner peripheral surface of the clamping ring 16 and the outer peripheral surface of the container body 12.

### Aspects

It will be understood by those skilled in the art that the plurality of exemplary embodiments described above is illustrative of the following aspects.

### Item 1

An X-ray analyzer according to a first aspect of the present invention comprising:
a sample container configured to accommodate a sample;
a placement portion capable of placing the sample container thereon;
an X-ray irradiation source configured to irradiate the sample in the sample container with X-rays from below the placement portion;
a detector configured to detect fluorescent X-rays generated from the sample below the placement portion; and
a holder placed on the placement portion, the holder being configured to accommodate the sample container,
wherein the placement portion is provided with an opening for passing X-rays emitted from the X-ray irradiation source,
wherein the sample container includes:
   a container body configured to surround the sample, the container body being formed in a shape having an opening opened downward; and
   a container film configured to close the opening of the container body and support the sample, and
wherein the holder includes:
   an enclosure cylinder having an outer shape larger than the opening of the placement portion, the enclosure cylinder being configured to surround the sample container, the enclosure cylinder being formed in a shape having an opening opened downward; and
   a holder film closing the opening of the enclosure cylinder.

In this X-ray analyzer, the holder film is further provided below the container film supporting the sample. Therefore, even in a case where the container film is damaged, dropping of the sample from the placement portion is suppressed.

### (Item 2)

In the X-ray analyzer as recited in the above-described Item 1, it may be configured such that the holder film is welded to a lower end portion of the enclosure cylinder.

In this aspect, the operation of attaching the holder film to the enclosure cylinder can be omitted.

### (Item 3)

In the X-ray analyzer as recited in the above-described Item 1, it may be configured such that the holder further includes a clamping ring attached to a circumference of the enclosure cylinder, and the clamping ring sandwiches an edge of the holder film between an inner peripheral surface of the clamping ring and an outer peripheral surface of the enclosure cylinder.

In this aspect, it is possible to attach a holder film made of a material that is difficult to weld to the enclosure cylinder (for example, a material that differs from the material constituting the enclosure cylinder) to the enclosure cylinder.

### (Item 4)

In the X-ray analyzer as recited in any one of the above-described Items 1 to 3, it may be configured such that the holder is configured to be detachable from the placement portion.

With this configuration, cleaning of the holder film, the replacement of the holder itself, etc., can be performed without causing damage to the X-ray irradiation source or the detector.

### (Item 5)

In the X-ray analyzer as recited in any one of the above-described Items 1 to 4, it is preferable that an outer shape of the container body be larger than the opening of the placement portion.

With this configuration, even in a case where the holder film is not attached to the enclosure cylinder, the sample can be analyzed by placing the sample container on the placement portion.

Description of Symbols

| | |
|---|---|
| 1: | X-ray analyzer |
| 10: | Sample container |
| 12: | Container body |
| 14: | Container film |
| 16: | Clamping ring |
| 20: | Casing |
| 22: | Housing |
| 24: | Placement portion |
| 24h: | Opening |
| 26: | Cover |
| 30: | X-ray irradiation source |
| 40: | Detector |
| 50: | Holder |
| 52: | Enclosure cylinder |
| 54: | Holder film |
| 56: | Clamping ring |
| S: | Sample |

1. An X-ray analyzer comprising:
a sample container configured to accommodate a sample;
a placement portion capable of placing the sample container thereon;
an X-ray irradiation source configured to irradiate the sample in the sample container with X-rays from below the placement portion;
a detector configured to detect fluorescent X-rays generated from the sample below the placement portion; and
a holder placed on the placement portion, the holder being configured to accommodate the sample container,
wherein the placement portion is provided with an opening for passing X-rays emitted from the X-ray irradiation source,
wherein the sample container includes:
a container body configured to surround the sample, the container body being formed in a shape having an opening opened downward; and
a container film configured to close the opening of the container body and support the sample,
wherein the holder includes:
an enclosure cylinder having an outer shape larger than the opening of the placement portion, the enclosure cylinder being configured to surround the sample container, the enclosure cylinder being formed in a shape having an opening opened downward; and
a holder film closing the opening of the enclosure cylinder, and
wherein an inner peripheral surface of the enclosure cylinder gradually decreases in diameter as it approaches the placement portion.

2. The X-ray analyzer as recited in claim 1,
wherein the holder film is welded to a lower end portion of the enclosure cylinder.

3. The X-ray analyzer as recited in claim 1,
wherein the holder further includes a clamping ring attached to a circumference of the enclosure cylinder, and
wherein the clamping ring sandwiches an edge of the holder film between an inner peripheral surface of the clamping ring and an outer peripheral surface of the enclosure cylinder.

4. The X-ray analyzer as recited in claim 1,
wherein the holder is configured to be detachable from the placement portion.

5. The X-ray analyzer as recited in claim 1,
wherein an outer shape of the container body is larger than the opening of the placement portion.
